(19) United States
(12) Patent Application Publication
(10) Pub. No.: US 2005/0260963 A1
(43) Pub. Date: Nov. 24, 2005

(54) Receiver system and method for wideband self test

(75) Inventors: Lorenzo A. Ponce De Leon, Lake Worth, FL (US); Abdel Sallam I Al Qatshan, Coconut Creek, FL (US); Dennis G. Anson, Coral Springs, FL (US); John Ballen, Parkland, FL (US); David J. Graham, Gilbert, AZ (US); Thomas R. Harrington, Margate, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/849,637

(22) Filed: May 19, 2004

(51) Int. Cl. H04B 17/00

(52) U.S. Cl. 455/226.3; 455/67.11

(57) ABSTRACT

A radio receiver self test system (10) that can test a plurality of bands in duplex cellular phones and other duplex communication devices can be constructed so that it operates during idle time slots. The system can be configured to test the performance of the radio receiver at all ranges of signal levels and in all channels. The system can include a receiver (14) and a transmitter (12) coupled to an antenna (28) and an antenna/noise switch (16). The switch can have as an input, a noise source (18) such as a broadband or thermal noise source. A baseband upconverter/downconverter module (24) can include a processor that provides control signals (27 and 26) for controlling the level of the noise source and for controlling the switch. The system can further include linear amplifier (20) on a receive path and a power amplifier (22) on the transmit path.

### CROSS-REFERENCE TO RELATED APPLICATIONS

Not applicable

### FIELD OF THE INVENTION

This invention relates generally to radio receiver testing, and more particularly to a method and system for a radio receiver system wideband self test.

### BACKGROUND OF THE INVENTION

Creating a radio receiver self test requires generating RF signals at all channels of operation. A conventional solution requires signal generators based on frequency stabilized VCOs and PLL circuits. To cover all the desired frequency bands, a conventional system would also require multiple VCOs. Such a test set-up with multiple VCOs likely exists in many manufacturing sites for testing radio receivers. Multiple VCOs on a radio receiver itself for testing purposes would unnecessarily increase the cost of a portable subscriber unit. Currently, no simple low cost solution exists for generating a broadband signal within a radio receiver unit for purposes of self-testing the receiver. Nor does a low-cost self-test exist that covers all radio channels, particularly in a broadband receiver.

### SUMMARY OF THE INVENTION

A receiver system and method for wideband self-test can provide a mobile/cellular phone with a receiver self test that operates over the all radio bands. The radio receiver self test system can test all the present day and future bands in duplex (CDMA, TDMA, GSM, iDEN, etc.) cellular phones or other duplex communication devices having transceivers. The self test system can be constructed to operate during idle time slots for a given protocol such as in time slots for CDMA or TDMA transmissions. The system can be configured to test the performance of the radio receiver at all ranges of signal levels and in all channels and can also be configured to test the performance of receiver subsystems for present day and future bands for all cellular phones. The circuitry for such self-test can be integrated using standard IC processes. Such a system can provide a broadband signal at low cost using thermal noise and broadband amplifiers.

In a first embodiment of the present invention, a wideband self-testing receiver system can include a receiver, a broadband noise source, an antenna/noise switch selectively coupled between the broadband noise source and the receiver, and a processor coupled to the antenna/noise switch and the broadband noise source. The broadband noise source can include an excess noise amplifier chain that generates noise power proportional to an amplifier gain and the excess noise amplifier chain can include an excess noise amplifier designed to be broadband, have a high noise factor, and a bandwidth exceeding the highest frequency of operation for the receiver. Alternatively, the broadband noise source can include a bank of amplifiers tuned to cover separate bands of operation for the receiver.

The processor can be programmed to control the gain level of the broadband noise source and to control the antenna/noise switch for routing noise from the broadband noise source to an appropriate receiver chain to enable the wideband self-testing receiver system to perform a self-test. The receiver can be a portion of a duplex CMDA or TDMA transceiver and the self-test can occur during at least one idle time slot such as a CDMA or TDMA time slot. The system can further include an antenna coupled to the receiver. The processor can be further programmed to test the performance of the receiver at substantially all ranges of signal levels and in substantially all channels available. The processor can also be programmed to alternatively introduce a known level of noise into a front end of the receiver, detect and measure a signal strength as the front end processes the known level of noise, and compare the signal strength measured with a stored value. Additionally, the processor can be programmed to perform a self-test on an automatic gain control circuit and to generate a diagnostic report via at least one among a radio channel, an infrared port, or a cabled connection to the processor.

In a second embodiment of the present invention, a method of self testing a duplex radio receiver can include the steps of selectively coupling a broadband noise source into a receiver chain and controlling the gain level of the broadband noise source to introduce a known level of noise into a front end of the receiver, detect and measure a signal strength as the front end processes the known level of noise, and compare the signal strength measured with a stored value. The controlling step can occur during at least one idle time slot such as during an idle CDMA or TDMA time slot. The method can further include the step of generating noise power proportional to an amplifier gain. The method can further include the step of testing the performance of the receiver at substantially all ranges of signal levels and in substantially all channels available. Additionally, the method can further include the step of generating a diagnostic report via at least one among a radio channel, an infrared port, or a cabled connection to the processor.

In a third embodiment of the present invention, a computer program can have a plurality of code sections executable by a machine for causing the machine to perform the steps of described in the embodiment above.

### BRIEF DESCRIPTION OF THE DRAWINGS

FIG. 1 is a block diagram of a receiver system capable of self-testing in accordance with an embodiment of the present invention.

FIG. 2 is a block diagram of another receiver system capable of self-testing in accordance with an embodiment of the present invention.

FIG. 3 is a block diagram of a receiver subsystem capable of self-testing in accordance with an embodiment of the present invention.

FIG. 4 is a chart illustrating RSSI and Delta RSSI response to excess noise in accordance with an embodiment of the present invention.

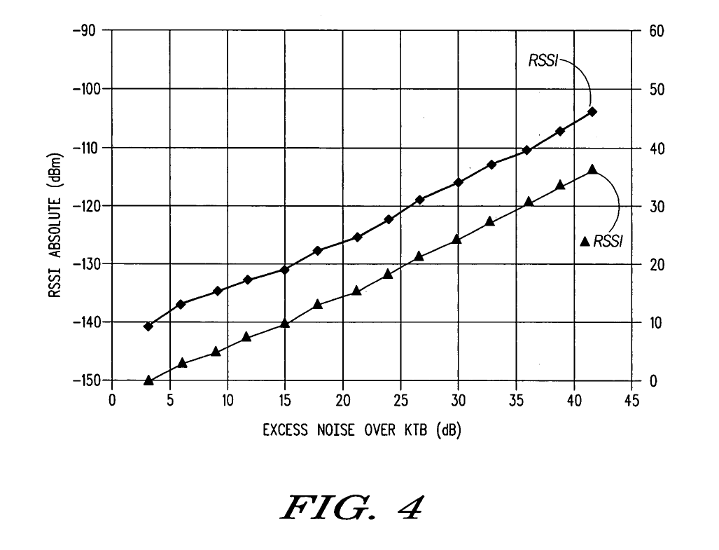

FIG. 5 illustrates flow chart of a method of self-testing a wideband receiver in accordance with an embodiment of the present invention.

### DETAILED DESCRIPTION OF THE DRAWINGS

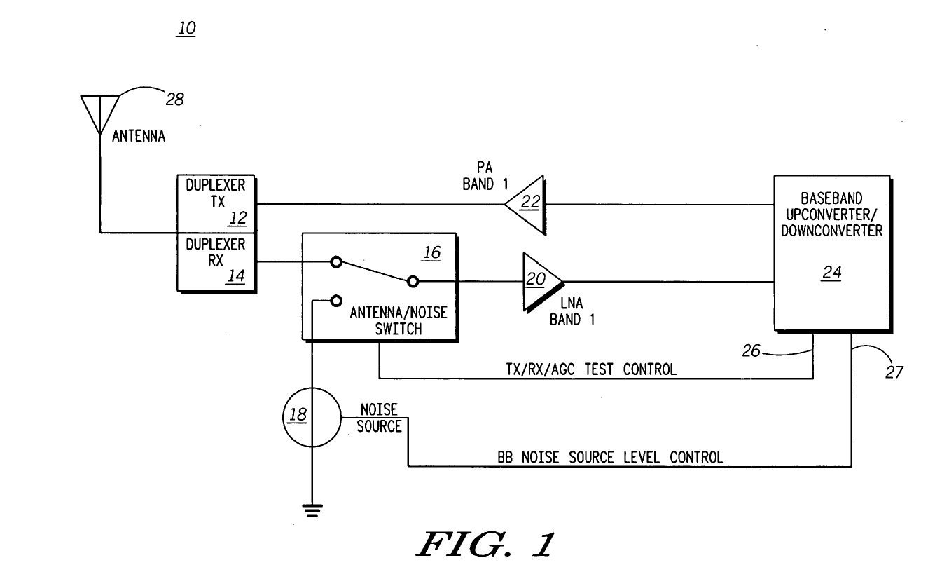

Referring to FIG. 1, a radio receiver self test system 10 that can test all the present day and future bands in duplex cellular phones and other duplex communication device is shown. The self test system is constructed so that it can operate during idle time slots such as in CDMA and TDMA time slots. The system 10 in particular can be configured to test the performance of the radio receiver at all ranges of signal levels and in all channels for a CDMA duplex receiver. The system 10 can include a transceiver or separate receiver 14 and transmitter 12 coupled to an antenna 28 and an antenna/noise switch 16. The switch 16 can have as an input, a noise source 18 such as a broadband or thermal noise source. A baseband upconverter/downconverter module 24 can include a processor that provides control signals 27 and 26 respectively for controlling the level of the broadband noise source 18 and for controlling the switch as further detailed below. The system 10 can further include linear amplifier 20 on a receive path and a power amplifier 22 on the transmit path. Of course, other amplifiers can be used in contemplation of various embodiments of the present invention.

The self test system can start with a noise source 18 created using an Excess Noise Amplifier chain for example. The Excess Noise Amplifier chain can generate excess noise power proportional to the amplifier gain as shown below:
Pself_test=F*kT*BW*Gain (Watt)
Were: F=Amplifier Chain Noise Factor
kT=Noise Spectral Density (Watt/Hz)
BW=radio channel noise bandwidth
Gain=Amplifier chain gain

The Excess Noise Amplifier can be designed to be broadband and have a high noise factor (F). The bandwidth of the Excess Noise Amplifiers can exceed the highest frequency of operation of the radio. Alternatively, banks of amplifiers tuned to cover separate bands are also contemplated herein.

The Excess Noise Amplifier gain can be controlled by a BB Noise Source level control (27) which acts as an Excess Noise AGC circuit. The gain control mechanism in the Excess Noise AGC circuit can be a programmable current source that sets the bias level of the amplifier chain. The gain level of the Excess Noise AGC can be controlled by a base processor (24) which programs the Excess Noise AGC via an Excess Noise Control bus.

The noise output of the Excess Noise Amplifier can be fed into the radio receiver front end via the Antenna/Noise Switch 16. A TR/RX/AGC Test control signal 26 is used to enable the switch and route the noise into the appropriate receiver chain.

The output of the Excess Noise Amplifier (18) can produce broadband noise from a few dB above the sensitivity threshold of the system to as high as 60 dB or more above the noise floor. The output level of the Excess Noise Amplifier can be controlled in steps of a few dB as desired. The performance and trigger points of the radio's own AGC can be checked with this self test by adjusting the output levels of the Excess Noise Amplifier 18 and comparing the curve with expected values. The radio's processor (24) can be programmed with software to perform a self test routine which can be performed during idle time slots.

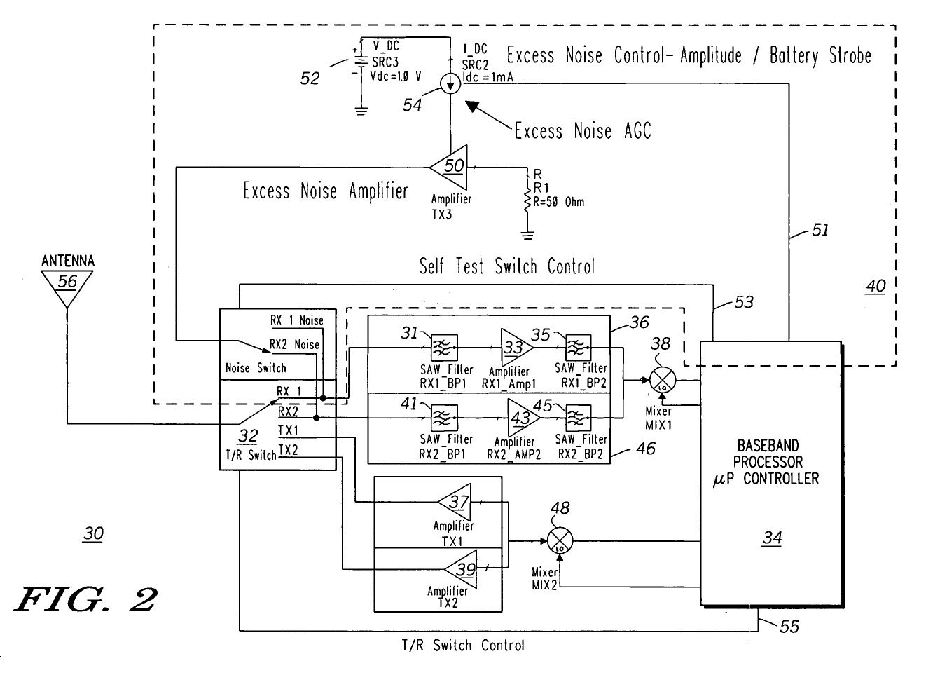

Referring to FIG. 2, a radio receiver self test system 30 that can test all the present day and future bands in TDMA cellular phones is shown. The self test system is constructed so that it can operate during idle time slots such as idle TDMA time slots. The system 30 can include separate receiver and transmitter paths coupled to an antenna 56 via a multi-pole/multi-throw transmitter/receiver (T/R) switch 32. The T/R switch 32 can have as inputs, a noise source 40 such as a broadband or thermal noise source, and control signals from a processor 34 such as a baseband processor microcontroller. The processor 34 provides a self-test switch control signal 53 to control when the noise source is applied and a transmitter/receiver switch control signal 55 to control the switching for the appropriate receiver and transmitter paths. The processor 34 also provide another control signal 51 for controlling the level of the broadband noise source 40 as will be further detailed below.

As shown, the system 30 can include multiple receive and transmit paths or chains. A first receive path 36 can include an amplifier 33 coupled between SAW filters 31 and 35 and a second receive path 46 can include an amplifier 43 coupled between SAW filters 41 and 45. Each of the receive paths can also include a mixer 38. A first transmit path can include a mixer 48 and an amplifier 37 while a second transmit path can include the mixer 48 and another amplifier 39.

As in the prior example of system 10 of FIG. 1, the self test system in the system 30 of FIG. 2 can start with a noise source 40 that generates excess noise power proportional to the amplifier gain having the relationship (as previously noted) of:
Pself_test=F*kT*BW*Gain (Watt)
The noise source 40 can use an Excess Noise Amplifier 50 designed to be broadband and have a high noise factor (F). The bandwidth of the Excess Noise Amplifiers can exceed the highest frequency of operation of the radio. Alternatively, banks of amplifiers tuned to cover separate bands are also contemplated herein.

The Excess Noise Amplifier gain can be controlled by the control signal 51 serving as an excess noise control signal for a programmable current source 54 which acts as an Excess Noise AGC circuit. The current source 54 can be powered by a power source 52 such as a battery. The gain control mechanism in the Excess Noise AGC circuit can use the programmable current source 54 to set the bias level of the amplifier chain. The gain level of the Excess Noise AGC can be controlled by the processor 34 which can program the Excess Noise AGC via an Excess Noise Control bus (51).

The noise output of the Excess Noise Amplifier can be fed into the radio receiver front end via the T/R Switch 32. The self-test switch control signal 53 is used to enable the switch and route the noise into the appropriate receiver chain.

The output of the Excess Noise Amplifier (50) can produce broadband noise from a few dB above the sensitivity threshold of the system to as high as 60 dB or more above the noise floor. The output level of the Excess Noise Amplifier can be controlled in steps of a few dB as desired. The performance and trigger points of the radio's own AGC can be checked with this self test by adjusting the output levels of the Excess Noise Amplifier 50 and comparing the curve with expected values. The radio's processor (34) can be programmed with software to perform a self test routine which can be performed during idle time slots.

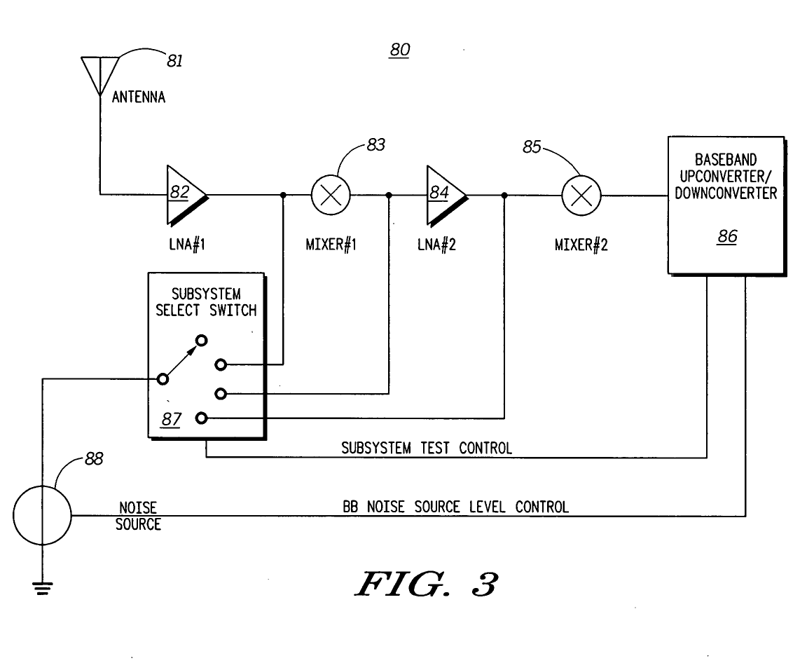

In yet another embodiment as shown in FIG. 3, a broadband noise subsystem receiver self test system 80 can test receiver subsystems in all the present day and future bands in cellular phones. The self test system is constructed so that it can operate during idle reception time slots. The system 80 can include an antenna 81, linear amplifiers 82 and 84, mixers 83 and 85, a processor 86, a subsystem select switch 87 and a noise source 88 as shown.

As in the prior examples of systems 10 and 30 of FIGS. 1 and 2 respectively, the self test system in the system 80 of FIG. 3 can start with a noise source 88 that generates excess noise power proportional to the amplifier gain having the relationship (as previously noted) of:
Pself_test=F*kT*BW*Gain (Watt)
The noise source 88 can use an Excess Noise Amplifier designed to be broadband and have a high noise factor (F). The bandwidth of the Excess Noise Amplifiers can exceed the highest frequency of operation of the radio and injects broadband noise in all the intermediate frequency (IF) bands in the subsystem. Alternatively, banks of amplifiers tuned to cover separate bands are also contemplated herein.

The Excess Noise Amplifier gain can be controlled by a broadband noise source level control signal from the processor 86 which can serve as an excess noise control signal for a programmable current source (not shown) which acts as an Excess Noise AGC circuit. The gain control mechanism in the Excess Noise AGC circuit can use the programmable current source to set the bias level of the amplifier chain. The gain level of the Excess Noise AGC can be controlled by the processor 86 which can program the Excess Noise AGC via an Excess Noise Control bus.

The noise output of the Excess Noise Amplifier can be fed into the radio receiver front end via the subsystem select switch 87. The processor 86 can be a baseband upconverter/downconverter that provides a subsystem test control signal to enable the subsystem select switch 87 and route the noise into the appropriate subsystem in the receiver chain.

The output of the Excess Noise Amplifier can produce broadband noise from a few dB above the sensitivity threshold of the system to as high as 60 dB or more above the noise floor. The output level of the Excess Noise Amplifier can be controlled in steps of a few dB as desired. The performance and trigger points of each subsystem AGC can be checked with this self test by adjusting the output levels of the Excess Noise Amplifier and comparing the curve with expected values. The radio's processor (86) can be programmed with software to perform a self test routine which can be performed during idle time slots.

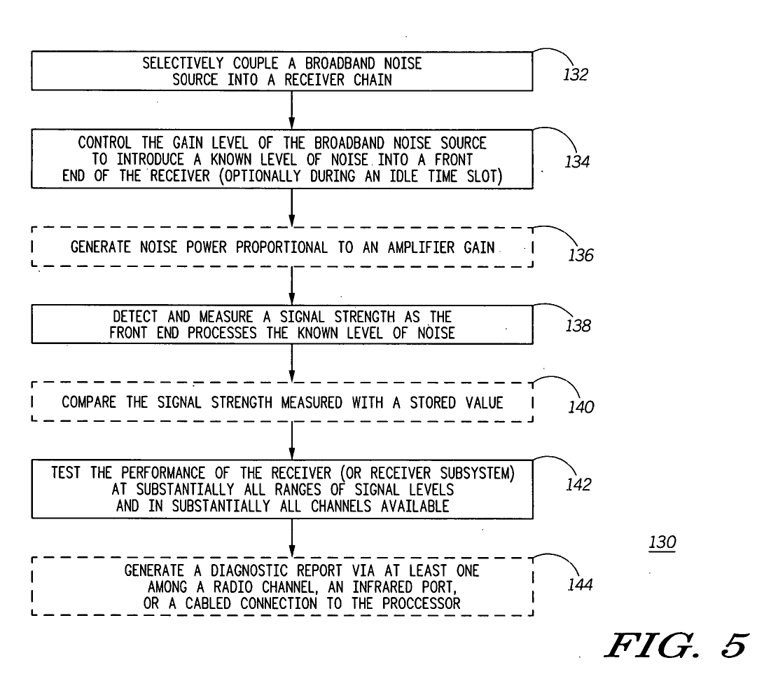

This self test can introduce a known level of noise into the front end of the receiver. The level of the noise as it processed by the radio through its front end can be detected and measured using for example a signal strength indicator such as RSSI (see FIG. 5). The noise level of the system during a self test is compared to a stored value. The processor can make a decision that either the system (10, 30 or 80) is operating within normal parameters or that there is a degradation in system performance causing the system to operate outside the normal parameters. Again, the performance and trigger points of the radio's own AGC (or each subsystem AGC) can be checked with this self test by adjusting the output levels of the Excess Noise Amplifier and comparing the curve with expected values. Additionally, the self test algorithm can include the option of generating a diagnostic report. This report can be relayed on request outside the radio using either a radio channel, an infrared (IR) port, or a cabled connection to the processor. In the manufacturing phase, the radio self test can be used to replace external test equipment and can speed-up back testing. In a service center, the results of the diagnostic report can be used to quickly isolate or rule out a radio related failure mechanism in the phone.

Referring to FIG. 5, a flow chart illustrating a method 130 of self testing a duplex radio receiver is shown. The method 130 can include the step 132 of selectively coupling a broadband noise source into a receiver chain and controlling at step 134 the gain level of the broadband noise source to introduce a known level of noise into a front end of the receiver. The method 130 can further detect and measure a signal strength at step 138 as the front end processes the known level of noise, and compare the signal strength measured with a stored value at step 140. The controlling step can occur during at least one idle time slot such as during an idle CDMA or TDMA time slot. The method 130 can further include the optional step 136 of generating noise power proportional to an amplifier gain. The method 130 can further include the step 142 of testing the performance of the receiver (or receiver subsystem) at substantially all ranges of signal levels and in substantially all channels available. Additionally, the method can further include the optional step 144 of generating a diagnostic report via at least one among a radio channel, an infrared port, or a cabled connection to the processor.

In light of the foregoing description, it should be recognized that embodiments in accordance with the present invention can be realized in hardware, software, or a combination of hardware and software. A receiver system and self testing arrangement or device according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

Additionally, the description above is intended by way of example only and is not intended to limit the present invention in any way, except as set forth in the following claims.

1. A wideband self-testing receiver system, comprising:
a receiver;
a broadband noise source;
an antenna/noise switch selectively coupled between the broadband noise source and the receiver;
a processor coupled to the antenna/noise switch and the broadband noise source, wherein the processor is programmed to control the gain level of the broadband noise source and to control the antenna/noise switch for routing noise from the broadband noise source to an appropriate receiver chain to enable the wideband self-testing receiver system to perform a self-test.

2. The system of claim 1, wherein the self-test occurs during at least one idle time slot.

3. The system of claim 1, wherein the self-test occurs during at least one CDMA idle time slot.

4. The system of claim 1, wherein the receiver is a portion of a duplex CDMA transceiver.

5. The system of claim 1, wherein the system further comprises an antenna coupled to the receiver.

6. The system of claim 1, wherein the broadband noise source comprises an excess noise amplifier chain that generates noise power proportional to an amplifier gain.

7. The system of claim 6, wherein the excess noise amplifier chain comprises an excess noise amplifier designed to be broadband, have a high noise factor, and a bandwidth exceeding the highest frequency of operation for the receiver.

8. The system of claim 1, wherein the broadband noise source comprises a bank of amplifiers tuned to cover separate bands of operation for the receiver.

9. The system of claim 1, wherein the processor is further programmed to test the performance of the receiver at substantially all ranges of signal levels and in substantially all channels available.

10. The system of claim 1, wherein the processor is further programmed to introduce a known level of noise into a front end of the receiver, detect and measure a signal strength as the front end processes the known level of noise, and compare the signal strength measured with a stored value.

11. The system of claim 1, wherein the processor is further programmed to perform a self-test on an automatic gain control circuit.

12. The system of claim 1, wherein the processor is further programmed to generate a diagnostic report via at least one among a radio channel, an infrared port, or a cabled connection to the processor.

13. A method of self testing a duplex radio receiver, comprising the steps of:
selectively coupling a broadband noise source into a receiver chain;
controlling the gain level of the broadband noise source to introduce a known level of noise into a front end of the receiver;
detecting and measuring a signal strength as the front end processes the known level of noise; and
comparing the signal strength measured with a stored value.

14. The method of claim 13, wherein the controlling step occurs during at least one idle time slot.

15. The method of claim 14, wherein the step of selectively coupling comprises the step of selectively coupling a thermal noise source.

16. The method of claim 13, wherein the method further comprises the step of generating noise power proportional to an amplifier gain.

17. The method of claim 13, wherein the method further comprises the step of testing the performance of the receiver at substantially all ranges of signal levels and in substantially all channels available.

18. The method of claim 13, wherein the method further comprises the step of generating a diagnostic report via at least one among a radio channel, an infrared port, or a cabled connection to the processor.

19. A machine readable storage, having stored thereon a computer program having a plurality of code sections executable by a machine for causing the machine to perform the steps of:
selectively couple a broadband noise source into a receiver chain; and
control the gain level of the broadband noise source to introduce a known level of noise into a front end of the receiver, detect and measure a signal strength as the front end processes the known level of noise, and compare the signal strength measured with a stored value.

20. The machine readable storage of claim 19, wherein the computer program further has a plurality of code sections executable by the machine for causing the machine to perform the step of controlling by controlling the gain level, detecting, measuring and comparing during an idle time slot.
